(19) United States
(12) Patent Application Publication
(10) Pub. No.: US 2015/0371326 A1
(43) Pub. Date: Dec. 24, 2015

(54) MOBILE FINANCIAL SOLUTION FOR UNBANKED AND UNDER-BANKED CONSUMERS

(71) Applicants: Pablo Montesano, Key Biscayne, FL (US); Etienne Gillard, Key Biscayne, FL (US); Sergio Carrera, Key Biscayne, FL (US)

(72) Inventors: Pablo Montesano, Key Biscayne, FL (US); Etienne Gillard, Key Biscayne, FL (US); Sergio Carrera, Key Biscayne, FL (US)

(21) Appl. No.: 14/311,407

(22) Filed: Jun. 23, 2014

(51) Int. Cl. G06Q 40/02; G06F 17/30; G06Q 20/32; G06Q 30/04; G06Q 20/22; G06Q 20/36

(52) U.S. Cl. CPC G06Q 40/025; G06Q 20/223; G06F 17/3053; G06Q 20/363; G06Q 20/3224; G06Q 30/04; G06Q 50/01

(57) ABSTRACT

A system for providing financial and payment services to individuals that are not part of the formal banking system. The system combines the use of a mobile wallet application, a reloadable prepaid card, a payment-processing platform and an analytics platform for determining a customer's trustworthiness based on information about his or her identity and his/her transaction profile. The system is useful for base of pyramid consumers such as immigrants that do not have a bank account, but need to make and receive payments nationally and internationally, as well as have access to small loans.

### BACKGROUND OF THE INVENTION

The present innovation relates to systems and methods for determining the trustworthiness of unbanked consumers and providing them with the ability to make financial transactions and receive loans via a mobile device.

Approximately 30% of the US' population is under-banked or unbanked. In many cases consumers do not qualify to open a bank account due to lack of funds or formal requirements. It is also the case many of these consumers are unbanked by choice, as they do not trust financial institutions or are not willing to pay the high fees usually associated with their services.

Being unbanked or under-banked does not mean that these consumers do not have financial management needs. Generally they perform financial transactions in more informal channels, with the following typical transaction profile:
Individual gets paid for his/her labor, many times with a check
He/she cashes the check at a check cashing store, usually paying anywhere between 1-10% of the check's value as commission
At this moment the customer also usually takes the opportunity to pay utility bills with the cash he/she just received. Check cashers charge a commission per bill, generally between $1 and $5
International money transfer services are also offered at these locations as many customers also send money to friends and family at their countries of origin
If the customer has a bank account he/she can apply for a payday loan at these locations. Unbanked consumers are excluded from this market and have no access to formal credit, therefore limiting their ability to deal with emergencies (illnesses, death of a relative, etc.) or borrow money for investments (home improvements, education, etc.)

Although the current service providers offer quick access to the cash and are widely extended in areas where these consumers tend to live, significant frictions still exist in this market:
Fees charged are usually very expensive
Transactions can only take place during regular business hours, which is when these consumers work
Inconvenience of getting to and from the cash checking location and the risk of getting robbed or losing the money.

What is desired is a system that facilitates greater efficiency and cost-effectiveness of how unbanked and under-banked consumers manage their money and the right incentives are put in place for lenders to lend them money.

### BRIEF SUMMARY OF THE INVENTION

The system combines the use of a mobile wallet application, a reloadable prepaid card, a payment-processing platform and an algorithm for determining a customer's trustworthiness to provide financial services for unbanked consumers.

The system assigns a trustworthiness index to the consumer based on the amount and validity of the information about his or her identity and location, as well as his transactional track record. This index, which can be thought of as a credit score for unbanked consumers, is communicated to the consumer together with basic information about the behaviors that help to increase it. Scores below a certain threshold imply the consumer will not be able to operate in the system. Conversely, a high score allows the consumer to have access to lower transactional fees, higher transaction limits, and have access to credit.

The system solution allows registered consumers to make check deposits by taking a picture of their checks, allowing them to receive their money instantly and safely in their mobile stored value account. The system also allows consumers to pay their bills and send money to national and international destinations. The physical prepaid card that enables 24×7 ATM withdrawals and merchant purchases.

The solution competes with physical cash checking stores for these transactions. The service delegates to each consumer the cash checking process, thus eventually doing away with the need to have a physical store, employees, safety boxes, and security systems. The system offers a scalable, low cost solution.

Consumers can self-enroll using the mobile application or register at a number of authorized physical enrollment locations, usually independent mom and pop stores such as mobile phone dealers, convenience stores, and insurance brokers.

The result is an improved solution for unbanked and under-banked consumers to manage their finances:
Cheaper cost of service
Ability to transact anywhere, anytime
More secure ways to store value other than cash
Leveraging new sources of information to extend credit

### DETAILED DESCRIPTION OF THE INVENTION

The system combines the use of a mobile wallet application, a reloadable prepaid card, a payment-processing platform and an algorithm for determining a customer's trustworthiness to provide financial services for unbanked consumers.

The mobile application is the main interface to the three types of profiles that use the system: the supervisors, the Enrollment Points and the end consumers. The sales force acquires and manages enrolments points, which register customers at a physical location and validate their identity. End consumers register and transact using the system as described earlier. The application can be downloaded directly at the mobile application stores, and serves to authenticate users, establish their location, initiate and validate transactions, and manage the account (review balance, find Enrollment Point and ATM locations, review recent transactions, change the password, and block/unblock the account). The mobile application allows the user to link his account to social media accounts for easy log in and as a way to provide verifiable information about a customer's identity.

The service gateway acts as an intermediary between the front end and the different systems involved in providing the service. It is the only system that has a complete view of all the requests and transactions carried out. It centralizes connections with third parties such as billers or international money transfer agents, and feeds information about customers and transaction to the database. It also connects to social media platforms that provide additional information about consumers and their trustworthiness.

A central database holds the universe of information generated by all stakeholders (Enrollment Points, registered users, active customers, company employees and investors). It stores information in different formats, including alphanumeric data, and images, including:
Information about supervisors (Name, mobile number, username, password, employee number, address, and ID type, number, and picture)
Enrollment Point information (customer number, name, mobile number, username, password, address, segment, ID type and number, ID picture, end user picture, card number assigned to end user, proof of residence picture and birth date)
End user information (Enrollment Point number, name, mobile number, username, password, address, segment, ID type and number, ID picture, Enrollment Point picture and card number assigned to Enrollment Point)
Transactional information (check deposit amount, check front image capture, check back image capture, biller, bill amount, biller account number, phone number of P2P receiver, P2P amount, time of transaction request, transaction status, and starting and ending balance)

The system connects to a prepaid card management system that acts as the single stored value account holding the funds of individual customers and Enrollment Points. This can take the form of an open loop platform (plastic and virtual cards leveraging the existing payment networks such as Visa and MasterCard) or a closed loop environment allowing private transactions amongst registered members. This system is flexible to meet compliance requirements and regulations (such as Know Your Customer and Anti Money Laundering) but at the same time keep in mind the requirements of unbanked consumers, such as non US issued IDs. This platform manages the accounts and transactions in real time, and allows managing fraudulent or risky behavior.

Another element of the system is the ability for unbanked consumers to deposit checks using their mobile phones. This is a technology that already is widely used for banked customers, but currently not accessible for unbanked consumers. The check processing system capture the images of the checks front and back taken using the mobile application, and processes the check for approval and clearing at the Federal Reserve. The mobile software is optimized to ensure the check image is valid and readable and that the check has been adequately endorsed and signed. Also the system can validate that the check has not been submitted previously.

The information collected allows the system to estimate the trustworthiness of consumers based on the information available on him/her and his/her behavior (as explained in FIG. 2). Currently there is no public system to score unbanked customers according to their risk, as current credit scoring systems rely in banking information.

Initially only a limited set of variables is used to calculate this index, although these variables will be expanded to include additional information as the system matures. This initial set of variables includes:
Gender
Whether customer has completed or not the online identity verification process
Whether customer has completed or not a physical identity verification process at an Enrollment Point
Whether customer has or not a valid Facebook account with a history greater than 2 years
Whether the customer has a valid social security number
Whether the customer provides a digital copy of a bill proving his home address
The number of months the customer has been an active customer in the system
The average number of transactions per month performed by the customer
The average balance in the account per month
The average amount of funds deposited into the account per month
The average number of days bills are paid before the bill due date

Each of these variables is assigned a specific weight as shown on FIG. 2 and a number between 0 (min. score) and 10 (max. score) is calculated for each customer. The score is used automatically by the system to determine the commercial conditions each consumer faces:
Block account if the score is below a certain threshold (e.g. rating below 3)
Increase transaction limits if the score is above a certain threshold (e.g. a rating above 5)
Be able to obtain discounts on transaction fees above a certain threshold (e.g. a rating above 7)
Be able to have a negative balance in the account with an assigned limit (e.g. $20-$1000) if the score is above a certain threshold (e.g. a rating above 8)

The customer is informed of his/her score and how to improve it, as an incentive to provide valid and plentiful information about their identity and also to maintain a good transactional behavior in the system.

Enrollment Points also have a specific score for them based on how efficient they are at enrolling trustworthy consumers and at maintaining good standards of in store communications, fee transparency and customer support. The Enrollment Point rating is based on the average scores of all customers enrolled at that point of sale (with a weight of 75%) and the results of a survey measuring channel communication and training

The Enrollment Point score is also a number between 0 and 10, and is used automatically by the system to determine the commercial conditions each Enrollment Point faces:
Block an Enrollment Point's account if his/her Enrollment Point score is below a certain threshold (e.g. an Enrollment Point Rating below 3)
Be able to obtain higher commissions if his/her Enrollment Point score is above a certain threshold (e.g. an Enrollment Point Rating above 7)

In-house sales supervisors will also have their own score, which will be calculated as the average rating of all the Enrollment Points that he/she has acquired.

The system allows to perform the following transactions: mobile check deposit, bill payments, international or national person to person money transfer, payments at merchants using the mobile account, coupons and discounts at selected merchants, loyalty points, card and card less ATM withdrawals, card merchant payments. The system also allows customers to receive small loans based on their trustworthiness index.

### BRIEF DESCRIPTION OF THE DRAWINGS

FIG. 1 describes each of the key system components, which are the Front-end mobile application, the service Gateway, the check processing system, the customer database, the customer scoring system and the prepaid card management system.

FIG. 2 describes the elements used in calculating the Proprietary Trustworthiness index.

FIG. 3 describes the customer self-registration process. Customers can download the mobile application and register into the system following a number of simple steps to validate his or her identity. This mobile know-your-customer process contemplates the possibility of the customer to associate his or her Facebook account to the system. The process also contemplates that the customer will take pictures of himself or herself, including his or her ID. Once the customer has successfully registered, their ID may be validated by providing additional information, such as proof of residence, social security number and Facebook account.

FIGS. 4 and 5 describe the customer registration process at an Enrollment Point. Customers that do not wish to enroll online, can go to an Enrollment Point, where they will be asked to show their ID and the Enrollment Point will enter their information into the system.

FIG. 6 describes the customer mobile user interface. The initial version of the system is to be directed towards US Hispanic consumers, and is therefore in Spanish. The main page of the mobile application shows the consumer's account balance and his or her trustworthiness score. It also allows consumers to perform a number of transactions: deposit checks, pay bills, send money nationally or internationally, manage their account and find the nearest ATMs or Enrollment Points.

FIG. 7 describes the mobile check deposit process. When a customer wants to deposit a check using the system, he or she endorses the checks and takes a picture of its front and back. The system then processes the transaction, and if accepted, proceeds to deposit the determined amount into the account. In parallel, the check clearing process takes place.

FIG. 8 describes the mobile bill payment process. When a customer wants to pay a bill using the system, he or she selects the biller's country, type, biller name, and introduces the account information and amount. If all the information is correct, the payment is processed and a confirmation message is sent to the payer.

FIG. 9 describes the process to send funds to another registered user of the system. The consumer can send money to another user of the system by introducing the amount and the phone number of the recipient.

FIG. 10 describes the process to send funds to an unregistered user of the system. The consumer can send money to a user that is not registered with the system. The sender introduces the country, amount and phone number of the recipient. If the user is in the Unites States, then the recipient will need to register in the system to collect the transfer. If it is an international remittance, then the recipient will be directed to an authorized agent where he or she will receive the funds in local currency.

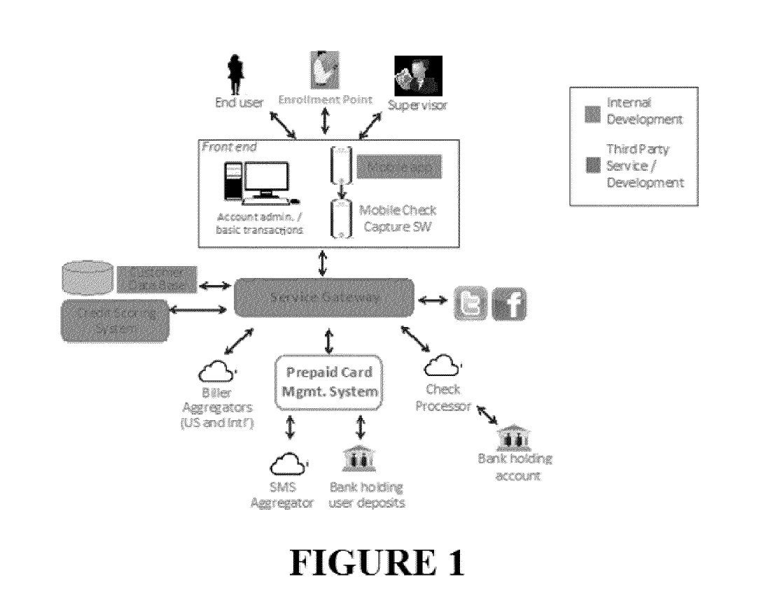

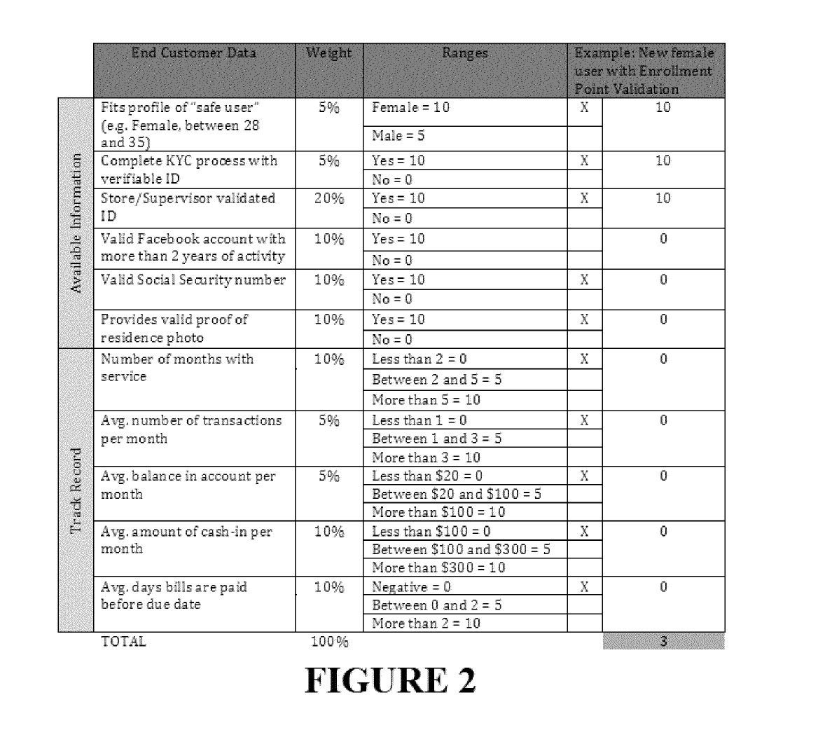

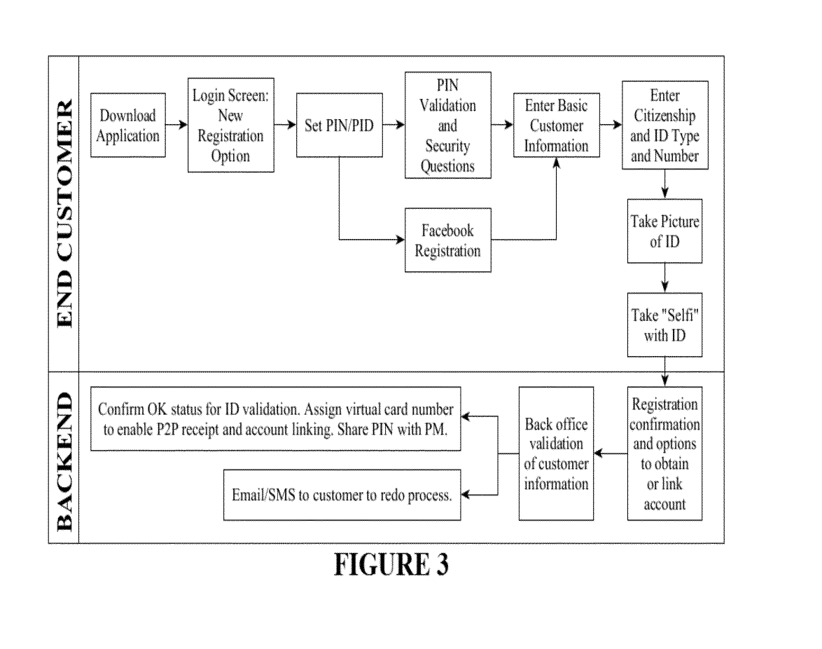

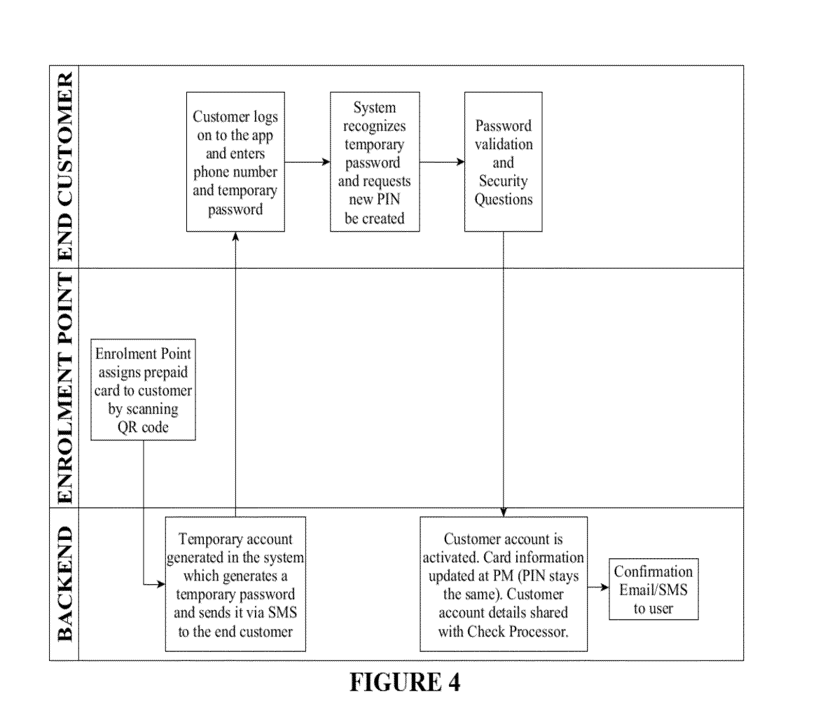

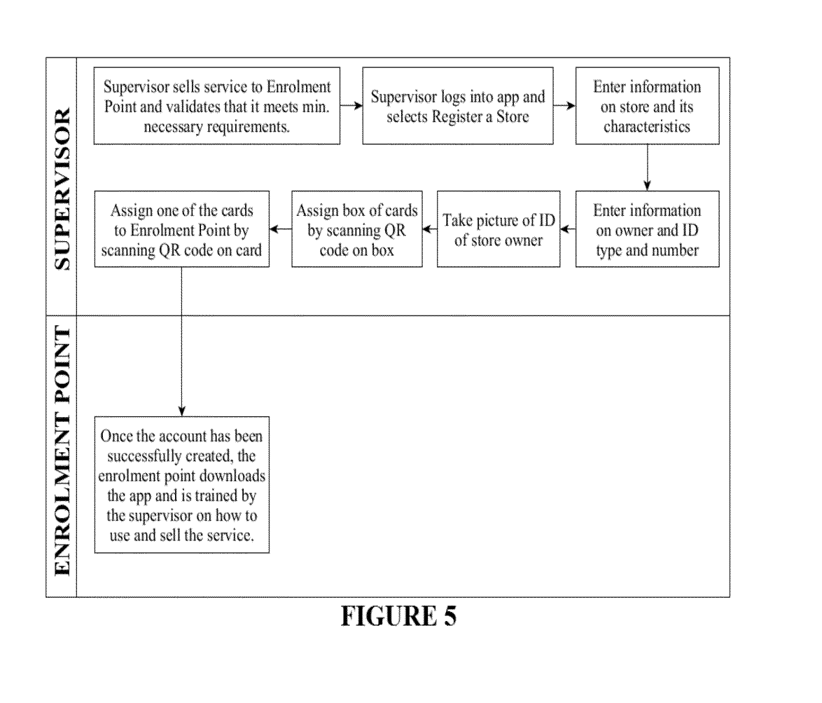

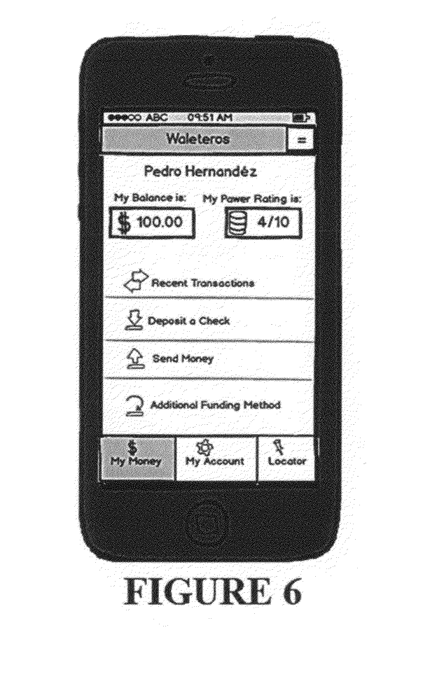

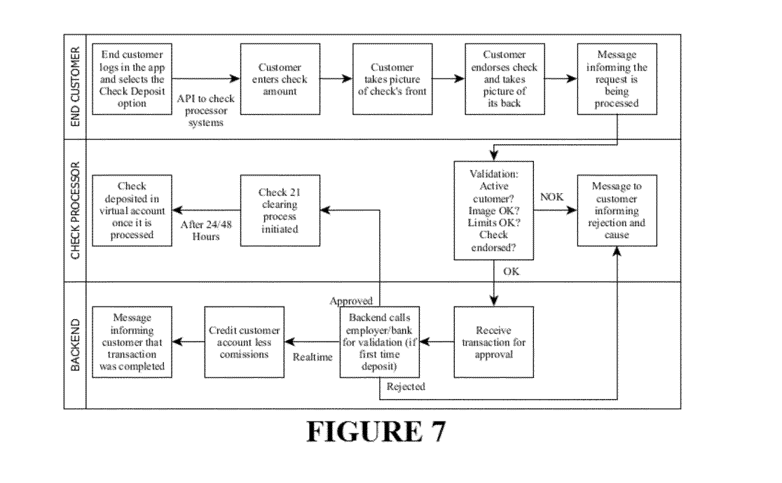

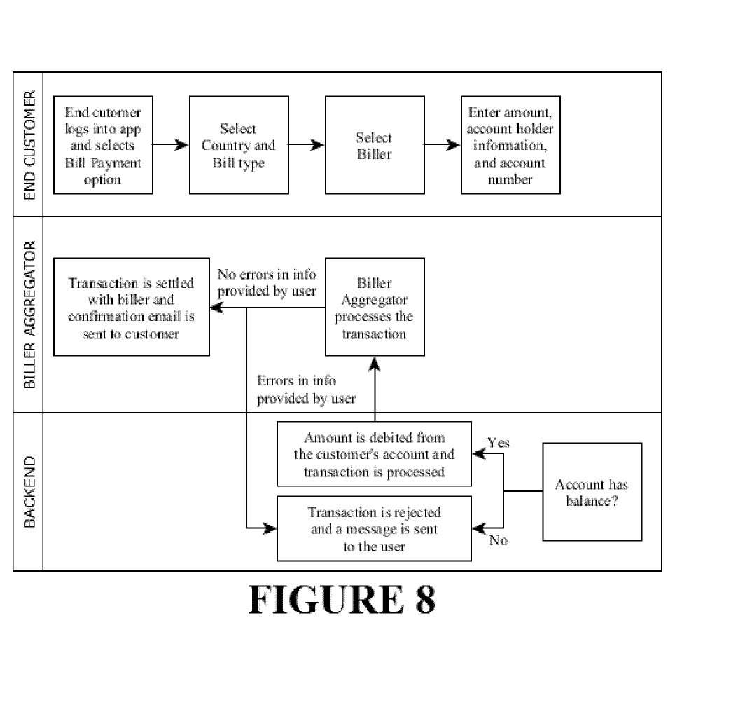

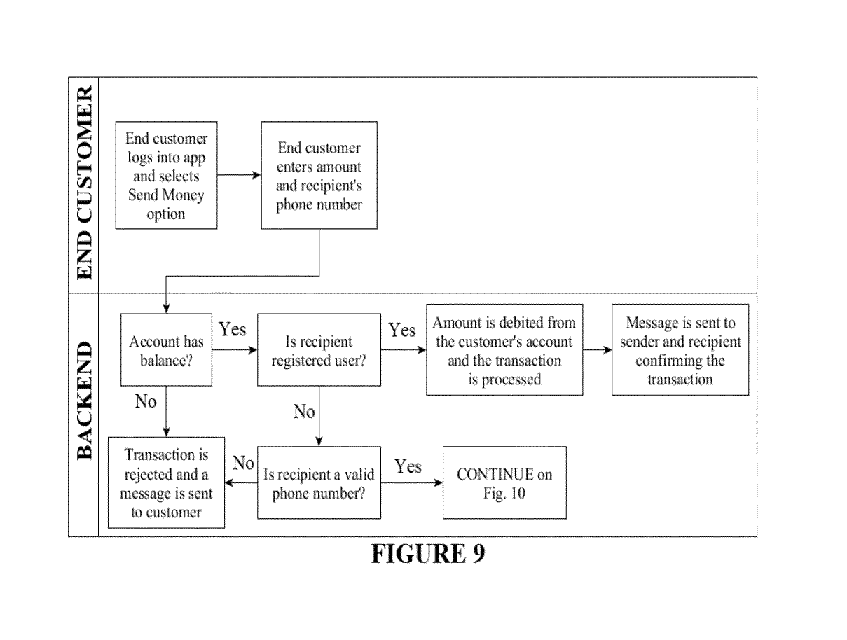

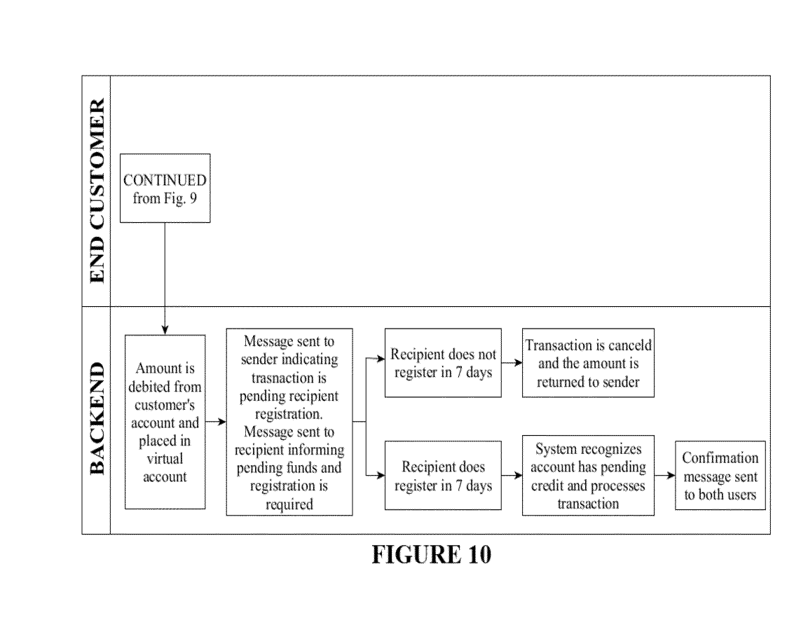

1. A mobile system for providing a public scoring index and financial and payment services to individuals that are not part of the formal banking system, comprising the following steps:
The customer enrolling in the system either by submitting relevant information remotely via a mobile application or enrolling at an authorized Enrollment Point
A method for validating the customer's identity online or at an Enrollment Point
A proprietary scoring mechanism based on stakeholder information, social media and transactional history to evaluate his or her trustworthiness and the ability to define account privileges and commercial conditions in line with this index
A mobile wallet application, a reloadable prepaid card, a payment-processing platform to perform financial transactions such as mobile check deposits, bill payment, merchant payments and money transfer
A mechanism to provide credit to unbanked consumers

2. The method of claim 1, wherein the mobile wallet comprises a set of interfaces and processes to determine and validate an unbanked customer's identity remotely

3. The method of claim 1, wherein an analytics platform collects customer information and activity data from sources via respective APIs.

4. The method of claim 1, wherein a set of payment and processing platforms are integrated together to form an end-to-end solution designed to service the financial needs of unbanked consumers

5. The method of claim 1, wherein information about the customer, his or her location, his or her presence on social media platforms, and his transaction profile is used to generate a score on his or her trustworthiness

6. The method of claim 1 where a picture is taken with a mobile device of a customer's ID and this image is processed, stored and analyzed to validate a customer's identity

7. The method of claim 1 where a self-picture is taken with a mobile device of a customer holding his or her ID and this image is processed, stored and analyzed to validate a customer's identity

8. The method of claim 1 where a picture is taken with a mobile device of a bill showing the customer's address is processed, stored and analyzed as proof of residence

9. The method of claim 1 where the average balance in the account, the number of transactions per month, the size of cash in transactions and the average number of days bills are paid before the bill due date are analyzed by the analytical platform to determine a trustworthiness score

10. The method of claim 1 where a trustworthiness score, the variables used to calculate it, and the commercial implications of a particular score are communicated to the customer

11. A method of determining commercial efficiency and ability to attract trustworthy unbanked consumers

12. The method of claim 11 where an Enrollment Point's score is calculated using the average trustworthiness score of the customers that were enrolled at that point of sale

13. The method of claim 11 where a supervisor's score is calculated using the average score of the Enrollment Points that he or she enrolled into the system

14. A method to allow unbanked consumers to use a mobile device to pay bills at their country of origin

15. The method of claim 14 where a combination of a mobile interface and a payments processing network is used to settle bills and payments in countries other than the United States in real-time or near-real-time

16. A method where a banked consumer pays an unbanked consumer for services using the system

17. A method of claim 16 where a banked consumer registers in the system in using a mobile device loads his or her account using a third-party-issued debit card or a third-party bank account

18. A method of claim 16 where a banked consumer performs a peer-to-peer transaction to pay an unbanked consumer that is a registered customer of the system, by introducing the recipient's phone number and amount

19. A method of claim 16 where a banked consumer performs a peer-to-peer transaction to pay an unbanked consumer that is a not a registered customer of the system, by introducing the recipient's phone number and amount.
